(19) United States
(12) Patent Application Publication
(10) Pub. No.: US 2005/0105612 A1
(43) Pub. Date: May 19, 2005

(54) Digital video stream decoding method and apparatus

(76) Inventors: Chih-Ta Star Sung, Glonn (DE); Jen-Shiun Chiang, Taipei (TW)

Correspondence Address: Chih-Ta Star Sung, RM. 308, BLD. 52, NO. 195, CHUNG HSING RD., SEC. 4, CHU TUNG TOWNSHIP, HSINCHU COUNTY, 310, TW

(21) Appl. No.: 10/712,138

(22) Filed: Nov. 14, 2003

(51) Int. Cl. H04N 7/12

(52) U.S. Cl. 375/240.2; 375/240.24; 375/240.12

(57) ABSTRACT

The present invention provides method and apparatus of digital video stream decoding. At least one compressed bit stream and decoded block pixels are saved in a storage device for comparing to a target block to determine whether one of previously decoded and saved blocks can be used to represent a target block. A lossless compression mechanism is applied to reduce the amount of pixel data during storing the decoded block pixels. A lossy method is applied in decoding the video stream if a sum of weighted differences of DCT coefficients between the closet block and a target block is less than a predetermined threshold.

### BACKGROUND OF THE INVENTION

1. Field of Invention

The present invention relates to digital video decompression, and, more specifically to an efficient video bit stream decoding method and apparatus that results in the saving of computing times for the inverse DCT calculation and VLC decoding.

2. Description of Related Art

Digital video has been adopted in an increasing number of applications, which include video telephony, videoconferencing, surveillance system, VCD (Video CD), DVD, and digital TV. In the past almost two decades, ISO and ITU have separately or jointly developed and defined some digital video compression standards including MPEG-1, MPEG-2, MPEG-4, MPEG-7, H.261, H.263 and H.264. The success of development of the video compression standards fuels wide applications. The advantage of digital image and video compression techniques significantly saves the storage space and transmission time without sacrificing much of the image quality.

Most ISO and ITU motion video compression standards adopt Y, Cb and Cr as the pixel elements, which are derived from the original R (Red), G (Green), and B (Blue) color components. The Y stands for the degree of “Luminance”, while the Cb and Cr represent the color difference been separated from the “Luminance”. In both still and motion picture compression algorithms, the 8×8 pixels “Block” based Y, Cb and Cr goes through the similar compression procedure individually.

There are essentially three types of picture encoding in the MPEG video compression standard. I-frame, the “Intra-coded” picture uses the block of 8×8 pixels within the frame to code itself. P-frame, the “Predictive” frame uses previous I-frame or P-frame as a reference to code the difference. B-frame, the “Bi-directional” interpolated frame uses previous I-frame or P-frame as well as the next I-frame or P-frame as references to code the pixel information. In principle, in the I-frame encoding, all “Block” with 8×8 pixels go through the same compression procedure that is similar to JPEG, the still image compression algorithm including the DCT, quantization and a VLC, the variable length encoding. While, the P-frame and B-frame have to code the difference between a target frame and the reference frames.

FIG. 1 shows a block diagram of the MPEG video compression procedure, which is most commonly adopted by video compression IC and system suppliers. In the case of I-frame or I-type macro block encoding, the MUX 110 selects the coming pixels 11 to directly go to the DCT, the Discrete Cosine Transform block 13, before the Quantization step 15. The quantized DCT coefficients are zig-zag scanned and packed as pairs of “Run-Level” code, which patterns depending on the occurrence will later be counted and be assigned code with variable length 17 to represent it. The compressed I-frame or P-frame DCT coefficients bit stream will then be reconstructed by the reverse route of compression procedure 19 and be stored in a reference frame buffer 16 as a reference for future frames. In the case of a P-type or B-type frame or macro block encoding, the macro block pixels are sent to the motion estimator 14 to compare with pixels within macro-block of previous frame for the searching of the best match macro-block The Predictor 12 calculates the pixel difference between a target 8×8 block and the best match block of previous frame (and next frame if B-type frame). The block pixel differences then feed into the DCT 13, quantization 15 and VLC 17 encoding, a similar procedure like the I-frame or I-type macro-block encoding.

Going through the decompression procedure, a compressed video data stream can be reconstructed. FIG. 2 illustrates the most commonly adopted video decompression procedure. Contradictorily to the compression procedure as mentioned in above paragraph, the compressed video data stream 21 of DCT coefficient enters the first step of a VLD 22, Variable Length Decoding, to recover the variable length DCT coefficients to be a fixed length of 8×8 DCT coefficients. The inverse quantization 23 rebuilds the filtered DCT coefficients. An inverse DCT 24 transforms the DCT coefficients in frequency domain back to time domain pixel data. If the video frame is a P-type or a B-type frame, the motion compensation procedure 25 is applied to restore the block pixels by adding the block differences and the referencing block pixels. The same decompression routine repeats block by block till the end of a frame and starts a new frame decompression with new compressed video data stream.

The mentioned block-by-block inverse-DCT calculation and the Huffman decoding consume a lot of computing times and therefore cost a lot of computing power. Accordingly, an improvement on the decompression algorithm plays important role in the speedup of the video decoding.

### SUMMARY OF THE INVENTION

The present invention is related to a method and apparatus of the video data decoding, which plays an important role in digital video decompression, specifically in decoding an MPEG video stream and JPEG still image stream. The present invention significantly reduces the computing times compared to its counterparts in the field of video stream decompression.
The present invention of the efficient video bit stream decoding saves the previous block DCT coefficients streams and the decompressed corresponding blocks pixels and compares to the coming video stream to determine whether a previously saved block pixels' are the same and can be used to represent the current block.
According to one embodiment of present invention, the P-type or B-type frame goes through the motion compensation procedure with the decompressed pixel differences which are obtained by comparing to the previously saved block DCT data.
According to another embodiment of the present invention, an I-frame or a JPEG picture saves previous DCT coefficients and the reconstructed blocks and compare to the present block.
According to another embodiment of the present invention, if no block with equal DCT coefficients, a block with closest DCT coefficients will be compared to a predetermined threshold said TH1 to determine whether a lossy decoding is acceptable.
According to another embodiment of the present invention, a weighted importance of the DCT coefficients is applied to decide the threshold, said TH1 which is the key of determining quality of the lossy decoding.
According to another embodiment of the present invention, the DCT coefficients closer to the DC left top corner have heavier weight for determining the said threshold value, said TH1.
According to another embodiment of the present invention, since the closer the blocks the higher similarity can be, due to potential limit of density, the storage device saves the compressed stream and the corresponding pixels of latest shown blocks.
According to another embodiment of the present invention, due to potential limit of density and high amount of decompressed block pixels, a lossless compression mechanism is applied to reduce the need of storage device for saving the decoded block pixels.
According to another embodiment of the present invention, due to space limit of the storage device, when saving the compressed bit stream and the corresponding decoded block pixels, the new bit stream has highest priority in storage since statistically neighboring blocks has higher similarity and the comparing starts from closest neighboring blocks.

It is to be understood that both the foregoing general description and the following detailed description are by examples, and are intended to provide further explanation of the invention as claimed.

### BRIEF DESCRIPTION OF THE DRAWINGS

FIG. 1 shows a simplified block diagram of the prior art video compression encoder.

FIG. 2 depicts the MPEG video decompression procedure with two referencing frames saved in off-chip frame buffer.

FIG. 3 is an embodiment of a video decompression method according to the present invention. FIG. 4 illustrates a decoding procedure according to the present invention.

FIG. 5 depicts the block diagram of the implementation of P-tep and B-type frames of the present invention of the video stream decoding with two referencing frames.

FIG. 6 depicts a procedure of lossless block pixel compression which results in data and storage device reduction.

FIG. 7 shows the block diagram of the implementation of the present invention of an I-frame or a JPEG picture.

### DESCRIPTION OF THE PREFERRED EMBODIMENTS

The present invention relates specifically to the digital video and image bit stream decoding. The method and apparatus quickly decodes the block bit stream data, which results in a significant saving of the computing times and power consumption.

There are in principle three types of picture encoding in the MPEG video compression standard including I-frame, the “Intra-coded” picture, P-frame, the “Predictive” picture and B-frame, the “Bi-directional” interpolated picture. I-frame encoding uses the 8×8 block of pixels within a frame to code information of itself. The P-frame or P-type macro-block encoding uses previous I-frame or P-frame as a reference to code the difference. The B-frame or B-type macro-block encoding uses previous I- or P-frame as well as the next I- or P-frame as references to code the pixel information. In most applications, since the I-frame does not use any other frame as reference and hence no need of the motion estimation, the image quality is the best of the three types of pictures, and requires least computing power in encoding. The encoding procedure of the I-frame is similar to that of the JPEG picture. Because of the motion estimation needs to be done in both previous and next frames, bi-directional encoding, encoding the B-frame has lowest bit rate, but consumes most computing power compared to I-frame and P-frame. The lower bit rate of B-frame compared to P-frame and I-frame is contributed by the factors including: the averaging block displacement of a B-frame to either previous or next frame is less than that of the P-frame and the quantization step is larger than that in a P-frame. Therefore, the encoding of the three MPEG pictures becomes tradeoff among performance, bit rate and image quality, the resulting ranking of the three factors of the three types of picture encoding are shown as below:

| | Performance | | |
|---|---|---|---|
| | (Encoding speed) | Bit rate | Image quality |
| I-frame | Fastest | Highest | Best |
| P-frame | Middle | Middle | Middle |
| B-frame | Slowest | Lowest | Worst |

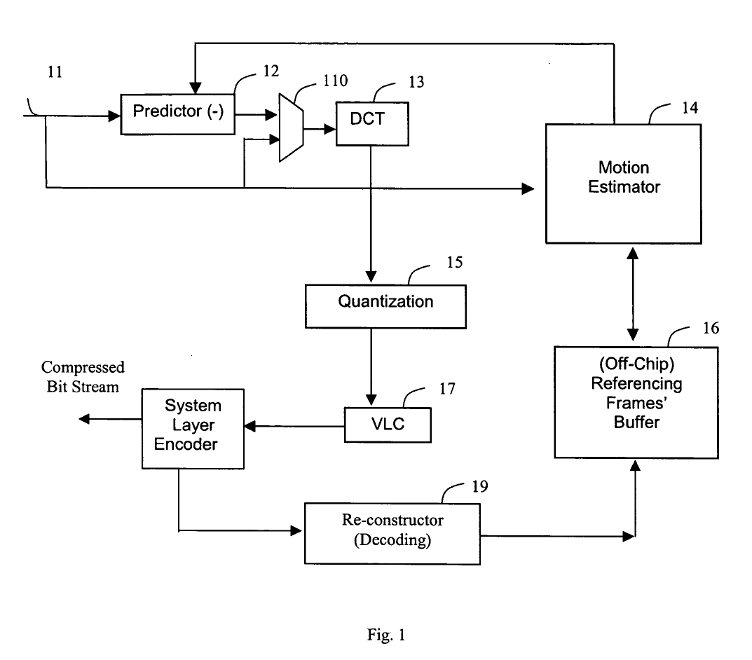

FIG. 1 illustrates the block diagram and data flow of the digital video compression procedure, which is commonly adopted by compression standards and system vendors. This video encoding module includes several key functional blocks: The predictor 12, DCT 13, the Discrete Cosine Transform, quantizer 15, VLC encoder 17, Variable Length encoding, motion estimator 14, referencing frames' buffer 16 and the re-constructor (decoding) 19. The MPEG video compression specifies I-frame, P-frame and B-frame encoding. MPEG also allows macro-block as a compression unit to determine which type of the three encoding means for the target macro-block. In the case of I-frame or I-type macro block encoding, the MUX 110 selects the coming pixels 11 to go to the DCT 13 block, the Discrete Cosine Transform, the module converts the time domain data into frequency domain coefficient. A quantization step 15 filters out some AC coefficients farer from the DC corner which do not dominate much of the information. The quantized DCT coefficients are packed as pairs of “Run-Level” code, which patterns will be counted and be assigned code with variable length by the VLC Encoder 17. The assignment of the variable length encoding depends on the probability of pattern occurrence. The compressed I-type or P-type bit stream will then be reconstructed by the re-constructor 19, the reverse route of compression, and will be temporarily stored in a referencing frames' buffer 16 for future frames' reference in the procedure of motion estimation and motion compensation. In the case of a P-frame, B-frame or a P-type, B-type macro block encoding, the coming pixels 11 of a macroblock are sent to the motion estimator 14 to compare with pixels of previous frames (and the next-frame in B-type frame encoding) to search for the best match macro-block. Once the best match macro-block is identified, the Predictor 12 calculates the block pixel differences between the target 8×8 block and the block within the best match macro-block of previous frame (or next frame in B-type encoding). The block pixel differences then feed into the DCT 13, quantizer and VLC encoder, the same procedure like the I-frame or I-type block encoding.

The said motion estimation is to search for the best match block of pixels in previous frame or next frame. The Best Match Algorithm, BMA, is most commonly used motion estimation algorithm in the popular video compression standards like MPEG and H.26x. The macro-block of a certain position having the least MAD, Mean Absolute Error or SAD, Sum of Absolute Distortion is identified as the “best match” macro-block. Once the best match blocks are identified, the MV between the target block and the best match blocks can be calculated and the differences between each block within a macro-block can be coded accordingly, this kind of block pixel differences coding technique is called “Motion Compensation” which results in significant reduction of data to be coded since it takes only the block differences instead of original pixel data. The block pixel differences between a target block and the best match block are coded by the means of said “Motion Compensation” and going through the image compression procedures including DCT, quantization and VCL encoding.

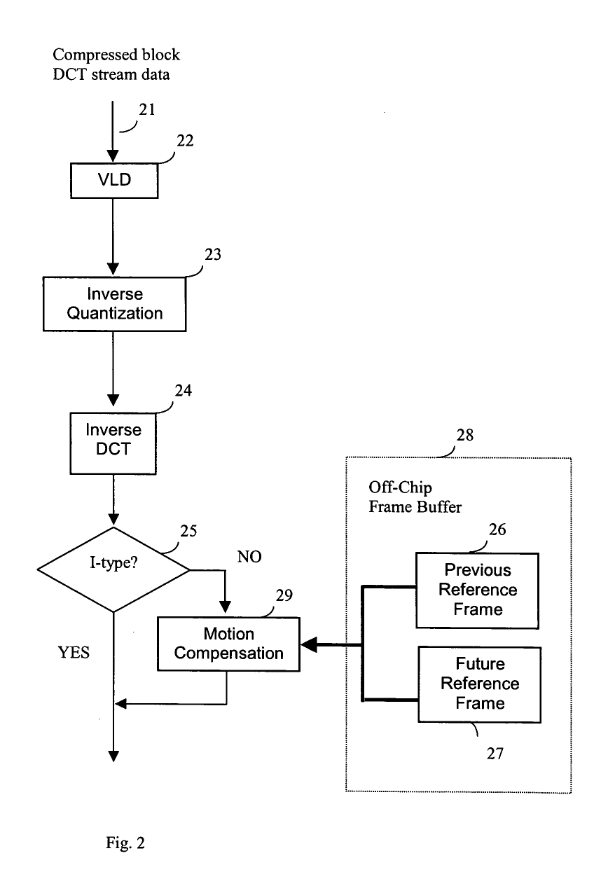

The compressed video stream data is in principal VLC coded DCT coefficients. The decompression procedure decodes the compressed stream data and reconstructs the pixel by the said motion compensation technique. FIG. 2 depicts the MPEG video decompression procedure with two referencing frames which for cost's reason are saved in off-chip frame buffer. The compressed video data stream 21 is firstly input to the VLD 22, the Variable length Decoder to be decoded back into a fixed array of the 8×8 DCT coefficients. For performance and cost's consideration, the VLD is most commonly implemented by a lookup table means. The inverse quantization 23 with the 8×8 quantization scales matrix multiply the VLD decoded DCT coefficients for each of the 8×8 DCT coefficients before it passes the DCT coefficients into the inverse DCT 24. The inverse DCT converts frequency domain 8×8 DCT coefficients into time domain 8×8 pixel values. In the case of I-type frame or block 25, the decoding process is completed in the inverse DCT. If the stream data is P-type or B-type frame or block, then the motion compensation 29 mechanism is needed to make up the block pixels by adding the referencing frame or block's pixels with the decoded block pixel values which is converted from inverse DCT. Since the referencing frames 28 consist of previous 26 and future 27 frames, for cost reason, it is commonly saved in an off-chip memory said frame buffer.

Decompressing the video stream costs materially high computing time and the computing time is proportional to the frame size or said the pixel density. The present invention significantly reduces the computing times compared to its counterparts in decompressing the video data stream.

The principle of the present invention of the video bit stream decoding is to save the previous block DCT coefficients streams and the decompressed corresponding blocks pixels and compare to the coming block DCT stream. If the coming block video stream data is equal to one of the previously saved block, then the decoded pixels are copied to represent the current block pixels. This easily saves the decoding procedure and reduces the times of computing.

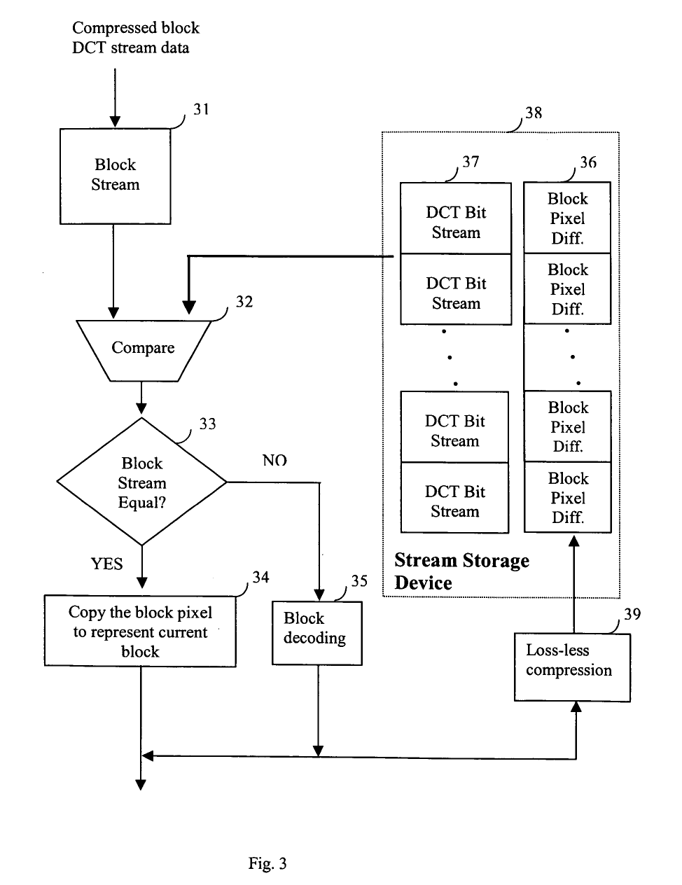

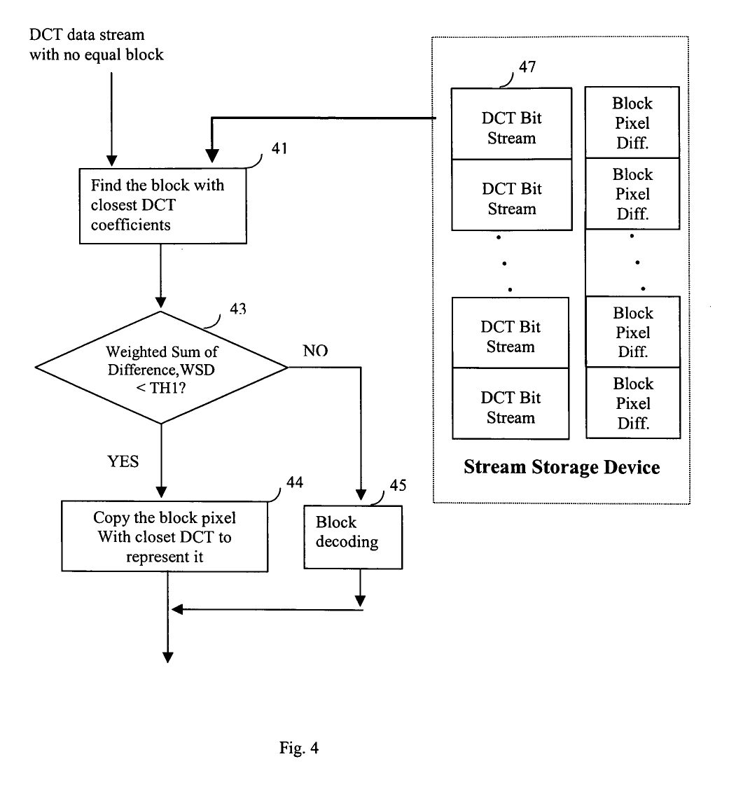

FIG. 3 illustrates the design flow of this invention. A coming compressed block DCT stream is temporarily stored in a block stream buffer 31 before the compressed DCT stream is compared to the previously saved DCT bit stream 37 and the corresponding “Block Pixel Difference” 36 which are stored in a temporary buffer 38. A comparator 32 is used to decide whether the coming block stream is equal to one of the previous blocks. Should one of the previously saved block stream is equal to the coming compressed block stream 33, the corresponding 8×8 array pixels are copied to represent the coming block of pixels 34. Only if no block of previously saved blocks is equal to the coming block, need the coming blocks to go though the block decoding 35 procedure. A-block decoding procedure is identical to the commonly followed decompression procedure as shown in FIG. 2 and described in previous section. Since the decoded pixel stream will have high volume of data, for saving the amount of temporary storage device, a lossless compression mechanism 39 is applied to compressed the decoded block pixels. In P-type and B-type frame or block, since the compression has filtered out a lot of high frequency information through quantization procedure, the decoded block pixel will show high correlation within the 8×8 block pixels. This makes the lossless compression easily achieve 4×-8× compression rate which also means a saving of 4× storage devices. In the present invention, the lossless compression takes advantage of close correlation of adjacent pixels and compress the data by taking the difference between adjacent pixels and the difference is fed to an VLC coder for data reduction. The P-type and B-type frame go through the motion compensation procedure with the decompressed pixel differences which are obtained by comparing to the previously saved block DCT data as described above. According to an embodiment of the present invention, an I-frame or a JPEG picture saves previous DCT coefficients and the reconstructed blocks and compare to the present block.

Since the inverse DCT consumes highest computing power during the video and still image decompression, it will benefit most if the computing of inverse DCT can be reduced. According to an embodiment of the present invention, a lossy algorithm of decompression is proposed to reduce the time of decompression. This algorithm is enforced only if the system design accepts the quality degradation.

FIG. 4 is a flowchart depicting the process of decoding a compressed video stream. DCT data stream with no equal block from previously saved blocks is conducted to search for a block of closest DCT coefficients 41. Since the DC and AC coefficients close to the left top DC corner of the DCT coefficient array dominate more information, according to an embodiment of the present invention, the weighted factors are assigned to each DCT coefficients array to sum up the difference of the previously saved block DCT coefficients 47 and the coming block. If the weighted sum of the difference 43, WSD is less than a predetermined threshold, TH1, the corresponding block pixels 46 are copied to represent the pixels of the coming block 44. If the WSD is larger than the threshold, TH1, then like the approach most counterparts adopt, a block decoding procedure will be enforced to reconstruct the block pixels.

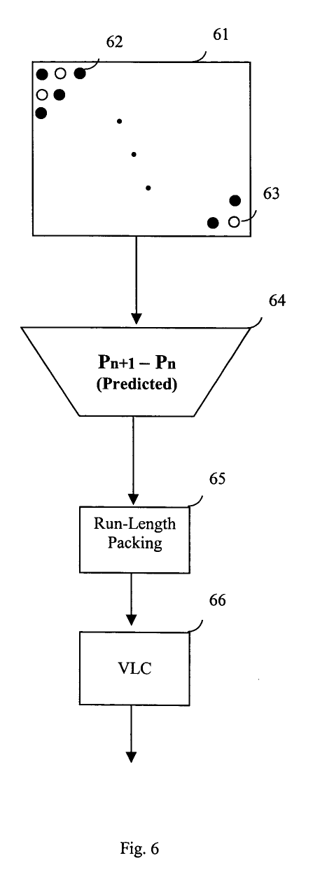

According to present invention, a lossless block pixel compression mechanism as shown in FIG. 6 is applied to reduce the amount of pixel data and hence the storage devices. The decoded block pixels are temporarily saved in a buffer 61 before it enters the first procedure of lossless compression. Each decoded pixels are subtracted from its corresponding predicted value 64, the results will show high percentage of “0s”. The more accurate the prediction mode is adopted, the high amount of the pixel difference will be “0” after subtract from the predicted pixels. A “Run-Length” pair stands for the amount (Run) of “0s” and the non-zero value followed. The R-L packing 65 is applied to pack the differences between the decoded pixels and the predicted values for VLC coding 66. Since the decoded pixels have been filtered the more high frequency information, the prediction should be easily done with higher accuracy. In the JPEG picture or an l-type frame or block, the average of 3×-4× lossless block pixel compression, while in the P-type or B-type frame or block, since the quantization scales are much larger than those in I-frame or JPEG picture, the lossless compression rate can hit 4×-6× without difficulties.

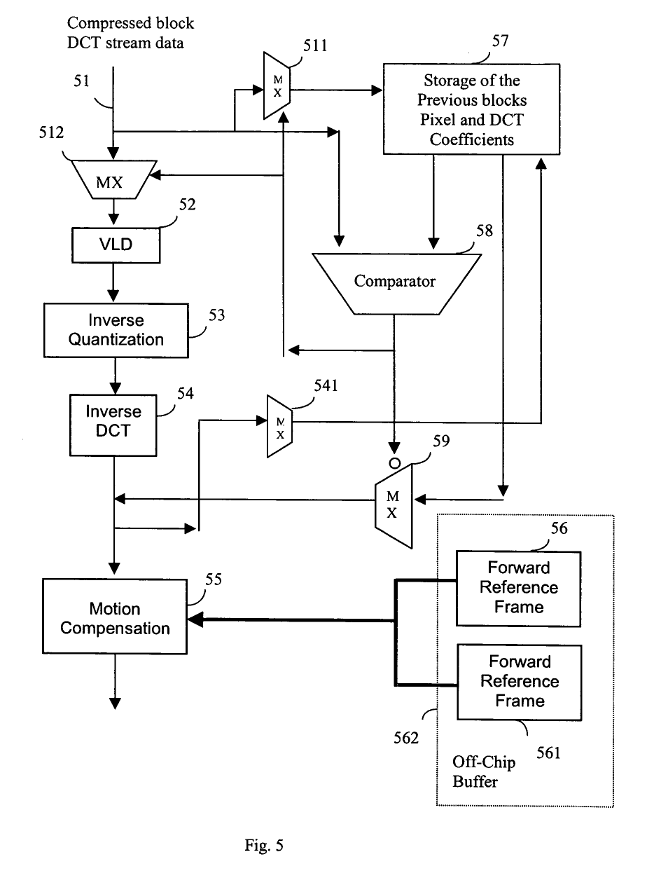

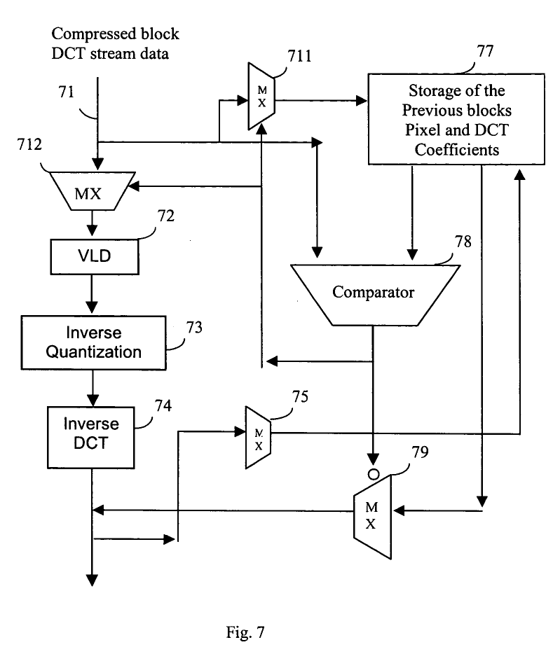

According to an embodiment of the present invention, a decoding device is implemented. FIG. 5 depicts the brief block diagram of the decoder for decompressing the video stream. The compressed video stream is compared 58 to the previously saved video bit stream to determine whether an equal block can be identified. Should there is an equal block in previous blocks, then the corresponding previously decoded pixels are selected 59 to represent a decoded block data and is fed into the motion compensation 55 for recovering the pixel by adding the block pixels saved in the frame buffers 562. If no identical block can be identified in previously saved blocks, the coming compressed stream is fed into the VLD 52 to firstly recover the 8×8 DCT coefficients. An inverse quantization 53 is to de-quantize each of the DCT coefficients with the corresponding quantization scale. Eventually, the inverse DCT 54 converts the frequency domain DCT coefficients back to time domain pixel data. While the decoded pixel information is feeding into the motion compensation, the compressed stream and the decoded pixel data is fed 541 into the storage device for comparing to future block streams. In JPEG or I-type frame or block video stream decompression as shown in FIG. 7, the decoding mechanism is the same as the P-type or B-type frame/block decompression except for that the last step of motion compensation of using the two referencing frames 56, 561 562 is skipped.

When saving the compressed bit stream and the corresponding decoded block pixels, the new bit stream has highest priority in storage since statistically neighboring blocks has higher similarity and the comparing starts from closest neighboring blocks. According to one embodiment of the present invention, the block stream comparing starts from neighboring block since statistically the similarity becomes higher among neighboring blocks.

It will be apparent to those skills in the art that various modifications and variations can be made to the structure of the present invention without departing from the scope or the spirit of the invention. In the view of the foregoing, it is intended that the present invention cover modifications and variations of this invention provided they fall within the scope of the following claims and their equivalents.

1. A method for decoding a video stream, comprising:
maintaining a DCT bit stream table in a storage medium, wherein the DCT reference bit stream table includes pairs composed of DCT reference bit streams and bock pixel data, the block pixel data providing inverse-DCT information of the corresponding DCT reference bit stream;
looking up the DCT bit stream table when receiving a DCT input stream to find whether the DCT input bit stream matches a DCT reference bit stream; and
utilizing the block pixel data corresponding to the matched DCT reference bit stream to generate inverse-DCT data of the DCT input bit stream if the DCT bit stream table includes the matched DCT reference bit stream.

2. The method of claim 1, further comprising the steps of decoding the DCT bit stream and saving the decoded result into the DCT bit stream table if the DCT input stream fails to matched any DCT reference bit stream in the DCT bit stream table.

3. The method of claim 2, further comprising the step of compressing the decoded result saved in the DCT bit stream.

4. The method of claim 1, wherein the DCT input bit stream and the DCT reference bit stream are matched if the DCT input bit stream and the DCT reference bit stream are identical.

5. The method of claim 1, wherein the DCT input bit stream and the DCT reference bit stream are matched if a difference of the DCT input bit stream and the DCT reference bit stream is lower then a predetermined threshold.

6. The method of claim 1, further comprising a step of representing a target block with a decompressed block pixels' within neighboring blocks if a compressed stream of the previously saved block streams is identical to a target block stream.

7. The method of claim 1, wherein a threshold value is compared to a weighted difference of compressed DCT coefficients of at least one previously saved block and a target block for determining the similarity.

8. The method of claim 7, wherein a weighted difference between at least one previously saved block stream and a target block stream is applied to determine whether a lossy decoding is applied in decompressing the video bit stream.

9. The method of claim 8, wherein one of previously saved decoded blocks is selected to represent a target block if a weighted sum of DCT coefficient difference between a target block and the closest block saved in the storage is less than a predetermined threshold.

10. The method of claim 1, wherein a compressed bit stream and the corresponding decoded pixels of farer distance from a target block can be overwritten when the storage device of storing compressed bit stream and decoded pixel is short of space.

11. The method of claim 1, wherein a decompressed bit stream is compressed before being stored to a buffer for future representing a new block stream.

12. The method of claim 1, wherein a decompressed bit stream is compressed through a lossless compression mechanism before being stored to a buffer and is decompressed for future representing a new block stream.

13. A method of lossless block pixel compression, comprising:
subtracting a pixel value from a predicted value to form a pixel difference matrix;
applying a “Run-Length” packing for re-arranging the pixel difference matrix into a pair of data; and
using a VLC coding scheme to reduce the amount of bit of representing the pixel difference patterns.

14. The method of claim 13, wherein a predicted pixel is calculated by an average of the weighted values of surrounding pixels.

15. The method of claim 13, wherein the surrounding pixels are pixel from left and top of a target pixel.

16. An apparatus for decoding a video stream, comprising:
a storage device for storing compressed data stream and corresponding decompressed pixel data of at least one previous block;
a device for comparing a coming compressed stream to at least one previously saved stream; and
a device of selecting one of previously saved decoded blocks to represent a target block if a target block is identical to one of the previously saved blocks.

17. The apparatus of claim 16, wherein an output of a comparator is used to select the decoded pixels to represent the target block pixels.

18. The apparatus of claim 16, wherein decoded block pixels represent the target block pixels by copying the decoded block pixels.

19. The apparatus of claim 16, wherein the surrounding pixels are pixel from left and top of a target pixel.

20. The apparatus of claim 16, wherein in decompressing an I-type frame and JPEG still pictures one of previously decoded and saved blocks is selected to represent the target block without going through a motion compensation device.

21. The apparatus of claim 20, wherein in decompressing an I-type frame and JPEG still pictures one of previously decoded and saved blocks is selected to represent the target block without going through a motion compensation device.
